(19) United States
(12) Patent Application Publication
(10) Pub. No.: US 2008/0205496 A1
(43) Pub. Date: Aug. 28, 2008

(54) Transceiver circuit capable of separating hybrid signals by current

(76) Inventors: Yi-Jen Huang, Tai-Nan City (TW); Jenn-Yue Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/782,644

(22) Filed: Jul. 25, 2007

(30) Foreign Application Priority Data
Feb. 27, 2007 (TW) 096106827

(51) Int. Cl. H04B 1/38

(52) U.S. Cl. 375/219

(57) ABSTRACT

A transceiver circuit capable of separating hybrid signal by current is disclosed. The transceiver circuit includes a transmission circuit, a digital/analog converting module for transmitting signals and a receiver circuit for receiving signals. The digital/analog converting module includes an input end for receiving a first digital signal, a first output end coupled to the transmission end for outputting a first current signal, and a second outputting end for outputting a second current signal. The first and the second current signals are generated according to the first digital signal. The first current signal is proportional to the second current signal. The second current signal for generating a replica transmission signal is used in receiver circuit for removing transmit signal from receive signal.

### BACKGROUND OF THE INVENTION

1. Field of the Invention

The present invention relates to a transceiver circuit of hybrid signals, and more particularly, to a transceiver circuit capable of separating hybrid signals by current.

2. Description of the Prior Art

Please refer to FIG. 1. FIG. 1 is a diagram illustrating a conventional transceiver circuit 100 of hybrid signals. As shown in FIG. 1, the transceiver circuit 100 comprises a digital/analog converter (DAC) 101, a receiving circuit 102, a resistor R1, a transformer T1, and a twisted pair line P1. The DAC 101 is coupled to a transceiver end X. The receiving circuit 102 is coupled to the transceiver end X. The resistor R1 is coupled between the transceiver end X and a ground end. The transformer T1 is coupled between the transceiver end X and the ground end. The twisted pair line P1 is coupled between the transformer T1 and the ground end.

Please continue referring to FIG. 1. When the conventional transceiver circuit 100 transmits data to a remote transceiver circuit, the DAC 101 receives a digital data Dt, and outputs current I with a corresponding size according to the digital data Dt. The resistor R1 generates a corresponding voltage Vx according to the current I. The transformer T1 generates a corresponding voltage Vy according to the voltage Vx to the twisted pair line P1. The twisted pair line P1 transmits the voltage Vy to the remote transceiver circuit.

Please continue referring to FIG. 1. When the transceiver circuit 100 receives data from the remote transceiver circuit, the twisted pair line P1 receives the voltage Vy so that the transformer T1 transforms the voltage Vy into the voltage Vx. Then the voltage Vx is input into the receiving circuit 102. The receiving circuit 102 generates a corresponding data Dr according to the voltage Vx, and thus the data receiving is completed.

When the transceiver circuit 100 transmits data to the remote transceiver circuit, because the current I transmitted from the DAC 101 has a leakage current xI to the receiving circuit 102, if the remote transceiver circuit also transmits data to the transceiver circuit 100, the voltage Vx received by receiving circuit 102 is affected by the leakage current xI, causing misreading of the data Dr.

### SUMMARY OF THE INVENTION

The present invention provides a transceiver circuit capable of separating hybrid signals by current comprising a transceiver end for transmitting or receiving signals; a digital/analog converting module comprising an input end for receiving a first digital signal; a first output end coupled to the transceiver end for outputting a first current signal; and a second output end for outputting a second current signal; wherein the digital/analog converting module convert the first digital signal into the first current signal and the second current signal, and the first current signal is proportional to the second current signal; and a receiving circuit coupled to the transceiver end and the second output end of the digital/analog converting module for outputting a second digital signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional transceiver circuit of hybrid signals.

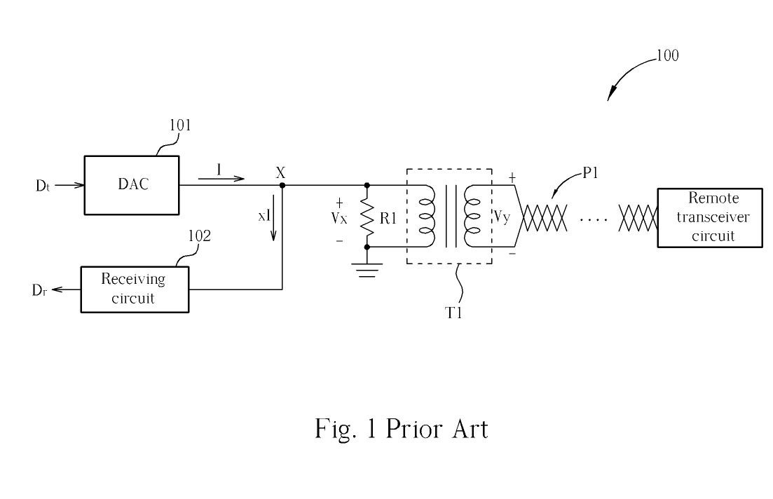

FIG. 2 is a diagram illustrating a transceiver circuit capable of separating hybrid signals by current.

FIG. 3 is a diagram illustrating a DAC module of the present invention.

FIG. 4 is a diagram illustrating a receiving circuit of the present invention.

FIG. 5 is a diagram illustrating the transceiver circuit of the present invention transmitting current to the buffer circuit.

FIG. 6 is a diagram illustrating details of the transceiver circuit of the present invention.

### DETAILED DESCRIPTION

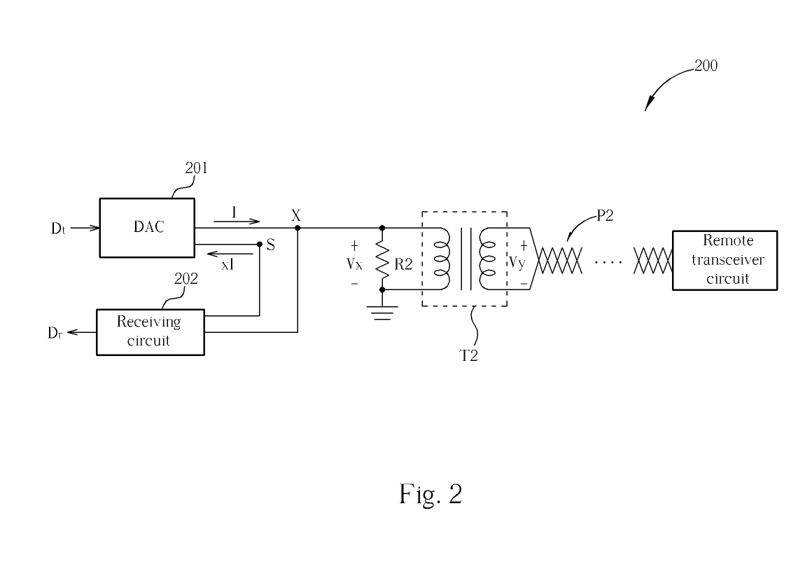

Please refer to FIG. 2. FIG. 2 is a diagram illustrating a transceiver circuit 200 capable of separating hybrid signals by current. The transceiver circuit 200 comprises a DAC module 201, a receiving circuit 202, a resistor R2, a transformer T2, and a twisted pair line P2. The DAC 201 is coupled to a transceiver end X and a node S. The receiving circuit 202 is coupled to the transceiver end X and the node S. The resistor R2 is coupled between the transceiver end X and a ground end. The transformer T2 is coupled between the transceiver end X and the ground end. The twisted pair line P2 is coupled between the transformer T2 and the ground end.

Please continue referring to FIG. 2. When the transceiver circuit 200 of the present invention transmits data to a remote transceiver circuit, the DAC module 201 receives a digital data Dt and accordingly outputs currents I and xI respectively to the transceiver end X and the node S. The direction of the current I is opposite to the direction of the current xI. The resistor R2 generates the voltage Vx according to the size of the current I. The transformer T2 generates another voltage Vy according to the voltage Vx and transmits the voltage Vy to the twisted pair line P2. The twisted pair line P2 transmits the voltage Vy to the remote transceiver circuit.

Please continue referring to FIG. 2. When the transceiver circuit 200 receives data from the remote transceiver circuit, the twisted pair line P2 receives the voltage Vy1, the transformer T1 transforms the voltage Vy1 into the voltage Vx1, and then the voltage Vx1 is input into the receiving circuit 202. The receiving circuit 202 generates the corresponding data Dr according to the voltage Vx1 and thus the data receiving is completed.

When the transceiver circuit 200 transmits data to the remote transceiver circuit and receives data from the remote transceiver circuit at the same time, since a leakage current xI flows to the receiving circuit 202, the transceiver circuit 200 is designed with another output end for generating a current xI with reverse polarity to the node S. Therefore, the current xI leaked to the receiving circuit 202 is cancelled by the current xI with reverse polarity and the receiving circuit 202 is able to correctly receive data Dr.

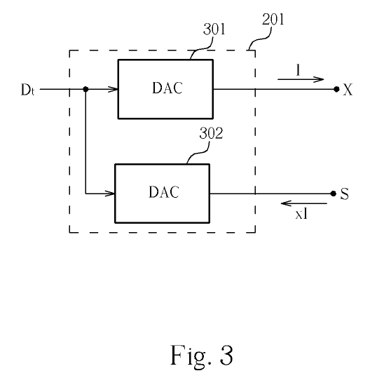

Please refer to FIG. 3. FIG. 3 is a diagram illustrating a DAC module 201 of the present invention. As shown in FIG. 3, the DAC module 201 comprises DACs 301 and 302 respectively utilized for generating current I and xI to the transceiver end X and the node S according to the data Dt. For example, it is assumed that x is 0.5, and when the data Dt is 1, the current I is 1 amp, and the current xI is 0.5 amp. When the data Dt is 2, the current I is 2 amps, and the current xI is 1 amp. (x=XI/I)

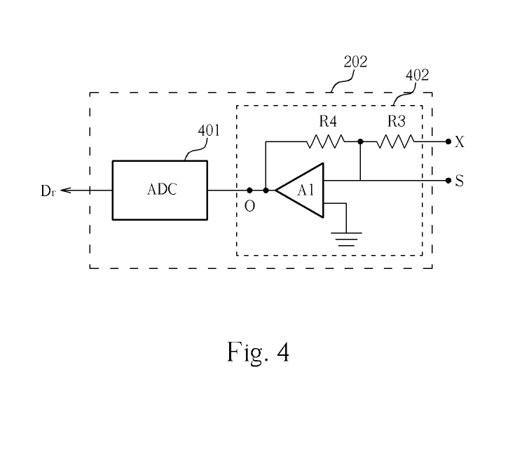

Please refer to FIG. 4. FIG. 4 is a diagram illustrating a receiving circuit 202 of the present invention. As shown in FIG. 4, the receiving circuit 202 comprises an analog/digital converter (ADC) 401 and a buffer circuit 402. The buffer circuit 402 is coupled between the transceiver end X, the node S, and the ADC 401 for buffering the received voltage Vx and transmitting the buffered voltage to the ADC 401. The ADC 401 generates the data Dr according to the buffered voltage. The buffer circuit 402 comprises an amplifier A1 and resistors R3 and R4. The resistor R3 is coupled between the transceiver end X and the node S. The resistor R4 is coupled between the node S and the output end O of the amplifier A1. The first input end of the amplifier A1 is coupled to the node S. The second input end of the amplifier A1 is coupled to a ground end. The output end of the amplifier A1 is coupled to the input end of the ADC 401. Thus, the amplifier A1 transmits the voltage [−(R4/R3)]Vx to the ADC 401 according to the voltage Vx.

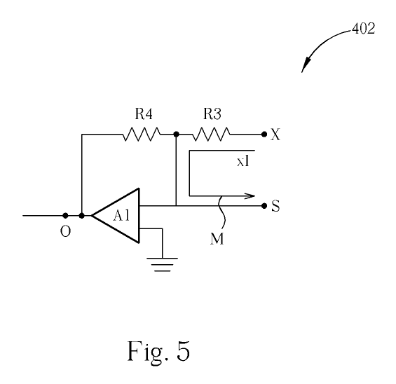

Please refer to FIG. 5. FIG. 5 is a diagram illustrating the transceiver circuit of the present invention transmitting current to the buffer circuit 402. As shown in FIG. 5, when the DACs 301 and 302 respectively output currents I and xI to the transceiver end X and the node S, since a leakage current xI from the current I of the DAC 301 leaks to the buffer circuit 402, thus the current xI with the reverse polarity of the DAC 302 is also transmitted to the buffer circuit 402, which cancels the leakage current xI from the current I of the DAC 301 and is as shown as the current path M in FIG. 5.

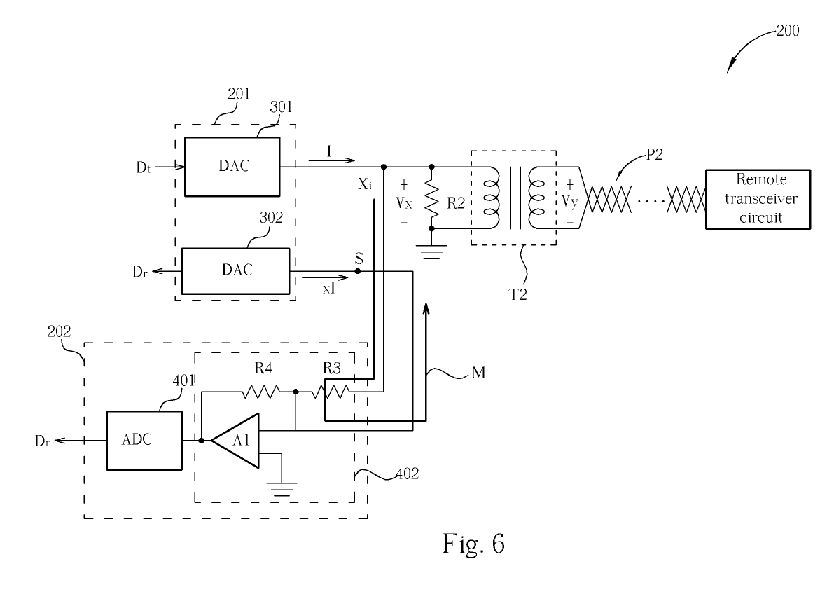

Please refer to FIG. 6. FIG. 6 is a diagram illustrating details of the transceiver circuit 200 of the present invention. The transceiver circuit 200 comprises a DAC module 201, a receiving circuit 202, 2 resistors R3 and R4, a transformer T2, a voltage supply V1 and a twisted pair line P2. The DAC module 201 is coupled to a transceiver end X and a node S. The receiving circuit 202 is coupled between the transceiver end X and the node S. The resistor R2 is coupled between the transceiver end X and a ground end. The transformer T2 is coupled between the transceiver end X and the ground end. The twisted pair line P2 is coupled between the transformer T2 and the ground end. The DAC module 201 comprises DACs 301 and 302. The receiving circuit 202 comprises an ADC 401 and a buffer circuit 402. The buffer circuit 402 comprises an amplifier A1 and resistors R3 and R4. The resistor R3 is coupled between the transceiver end X and the node S. The resistor R4 is coupled between the node S and the output end O of the amplifier A1. The first input end of the amplifier A1 is coupled to the node S. The second input end of the amplifier A1 is coupled to a ground end. The output end O of the amplifier A1 is coupled to the input end of the ADC 401. The description about related operation is the same as those described above and is omitted. The current path M is for illustrating when the leakage current xI of the current I flows into the buffer circuit 402, the current path M provides the path for the leakage current xI (xI=Vx/R3) to flow out from the buffer circuit and back into the DAC 302. Thus, the leakage current xI does not affect the buffer circuit 402.

To sum up, the present invention effectively transmits data to remote ends, and correctly receives data from remote ends with being interference of self transceiver circuit, which raise convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transceiver circuit capable of separating hybrid signals by current comprising:
a transceiver end for transmitting or receiving signals;
a digital/analog converting module comprising:
an input end for receiving a first digital signal;
a first output end coupled to the transceiver end for outputting a first current signal; and
a second output end for outputting a second current signal;
wherein the digital/analog converting module convert the first digital signal into the first current signal and the second current signal, and the first current signal is proportional to the second current signal; and
a receiving circuit coupled to the transceiver end and the second output end of the digital/analog converting module for outputting a second digital signal;
wherein the digital/analog converting module utilizes the second current signal output from the second output end of the digital/analog converting module for reducing affect of a leakage current signal of the first current signal to the receiving circuit.

2. The transceiver circuit of the claim 1 further comprising:
a ground end for providing a reference voltage level;
a first resistor coupled between the ground end and the transceiver end for receiving the first current signal and converting the first current signal into the first voltage signal; and
a transformer coupled between the ground end and the transceiver end for generating a second voltage signal according to the first voltage signal.

3. The transceiver circuit of claim 1 wherein the receiving circuit comprises:
a buffer circuit coupled to the transceiver end and the second output end of the digital/analog converting module for buffering voltages received by the transceiver end; and
an analog/digital converter coupled to an output end of the buffer circuit for outputting the second digital signal according to voltages outputted by the buffer circuit.

4. The transceiver circuit of claim 3 wherein the buffer circuit comprises:
a first resistor coupled between the transceiver end and the second output end of the digital/analog converting module;
an amplifier comprising:
a first input end coupled to the second output end of the digital/analog converting module;
a second input end coupled to the ground end; and
an output end for outputting a third voltage signal; and
a second resistor coupled between the second output end of the digital/analog converting module and the output end of the amplifier.

5. The transceiver circuit of claim 1 wherein the digital/analog converting module comprises:
a first digital/analog converter coupled between the input end of the digital/analog converting module and the first output end of the digital/analog converting module for generating the first current signal according to the first digital signal; and
a second digital/analog converter coupled between the input end of the digital/analog converting module and the second output end of the digital/analog converting module for generating the second current signal according to the first digital signal.

6. The transceiver circuit of claim 2 further comprising a twisted pair line comprising:
a first twisted line coupled between the transformer and an external circuit; and
a second twisted line coupled between the ground end and the external circuit.
